(19) United States
(12) Patent Application Publication
(10) Pub. No.: US 2009/0005929 A1
(43) Pub. Date: Jan. 1, 2009

(54) Vehicle behavior learning apparatuses, methods, and programs

(75) Inventors: Koichi Nakao, Okazaki-shi (JP); Masaki Nakamura, Okazaki-shi (JP); Tomoaki Ishikawa, Okazaki-shi (JP); Motoki Kanba, Okazaki-shi (JP); Osamu Aisaka, Okazaki-shi (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 12/213,076

(22) Filed: Jun. 13, 2008

(30) Foreign Application Priority Data
Jun. 29, 2007 (JP) 2007-172142

(51) Int. Cl. G06F 17/00

(52) U.S. Cl. 701/35

(57) ABSTRACT

Vehicle behavior learning apparatuses, methods, and programs acquire image information of an area around a vehicle and perform image recognition of a particular feature included in the image information. The apparatuses, methods, and programs detect a behavior of the vehicle and acquire relation information indicating the relationship between the detected behavior of the and the recognized particular feature before the recognition of the behavior. The apparatuses, methods, and programs store detected behavior information including behavior property information indicating a property of the detected behavior of the vehicle and the acquired relation information associated with the behavior in a memory and produce learned behavior information indicating a result of learning of the behavior related to the particular feature on the basis of the stored detected behavior information.

### INCORPORATION BY REFERENCE

The disclosure of Japanese Patent Application No. 2007-172142, filed on Jun. 29, 2007, including the specification, drawings, and abstract thereof, is incorporated herein by reference in its entirety.

### BACKGROUND

1. Related Technical Fields

Related technical fields include apparatuses, methods, and programs adapted to learn the behavior of a vehicle.

2. Related Art

When a driver drives a vehicle a plurality of times along the same route, there is a high probability that a particular behavior occurs at a particular point on the route. Such behaviors include making a turn to left or right, acceleration or deceleration, opening or closing a window, turning a light on or off, changing gear of an automatic transmission, and the like, on the way to a particular location such as home, an office, a shop, and the like. In recent years, navigation apparatuses that provide route guidance have become very popular.

Japanese Unexamined Patent Application Publication No. 2002-286459 discloses a control apparatus adapted to control a blind spot monitor in cooperation with a navigation apparatus installed in a vehicle. In the control apparatus of the blind spot monitor disclosed in Japanese Unexamined Patent Application Publication No. 2002-286459, when a manual switch is operated to activate the blind spot monitor, data associated with the location of the vehicle is acquired from the navigation apparatus and stored as activation information in the control apparatus. In later operation, information indicating the current vehicle position supplied from the navigation apparatus is compared with the activation information to check whether the vehicle is at the location where the blind spot monitor was activated before. If it is detected that the vehicle is at such a location, the control apparatus outputs an activation signal to activate the blind spot monitor.

The navigation apparatus manages road information on the basis of links connecting between nodes such as intersections. When the manual switch is operated at a point on a road assigned a link number, activation information is produced so as to include information indicating the link number, the coordinates of the point, and the running direction of the vehicle, and the produced activation information is stored. When the road has no assigned link number, activation information is produced so as to include the coordinates of the point and the running direction of the vehicle. The point at which the vehicle is located is determined using a hybrid system that is a combination of a GPS (Global Positioning System) device and an autonomous navigation device adapted to estimate the position from a vehicle speed signal supplied from a vehicle speed pulse sensor or an angular velocity signal supplied from an angular velocity sensor.

### SUMMARY

In the control apparatus of the blind spot monitor disclosed in Japanese Unexamined Patent Application Publication No. 2002-286459, the position of the vehicle is determined using the hybrid system. However, a measured position value includes an error, whether the position is determined by the GPS or autonomous navigation. This means that the hybrid system does not necessarily indicate a precise vehicle position at which the vehicle is actually located. To avoid this problem, map matching is used to estimate the position at which the vehicle is very likely to be located.

There is a high probability that a particular behavior of a vehicle such as activation of the blind spot monitor occurs at a particular point, for example, turning to the right/left from a wide road to a narrow road. Similarly, a transmission kick-down occurs when a vehicle is approaching a particular point such as a home, an office, a shop, and the like. There is a large number of narrow streets or side roads branching from a corresponding one of wide roads, and many of them are spaced a very small distance apart from each other. If the distance between adjacent narrow streets is smaller than a minimum detectable distance of the navigation system, it is difficult to predict a behavior of a vehicle from only a measured position of the vehicle.

Exemplary implementations of the broad principles described herein provide vehicle behavior learning apparatuses, methods, and programs capable of performing precise learning on a behavior of a vehicle which occurs at a particular point.

Exemplary implementations provide vehicle behavior learning apparatuses, methods, and programs that acquire image information of an area around a vehicle and perform image recognition of a particular feature included in the image information. The apparatuses, methods, and programs detect a behavior of the vehicle and acquire relation information indicating the relationship between the detected behavior and the recognized particular feature before the recognition of the behavior. The apparatuses, methods, and programs store detected behavior information including behavior property information indicating a property of the detected behavior of the vehicle and the acquired relation information associated with the behavior in a memory and produce learned behavior information indicating a result of learning of the behavior related to the particular feature on the basis of the stored detected behavior information.

### BRIEF DESCRIPTION OF THE DRAWINGS

Exemplary implementations will now be described with reference to the accompanying drawings, wherein:

FIG. 1 is a block diagram schematically illustrating an exemplary navigation apparatus including a vehicle behavior learning apparatus;

FIG. 2 is a diagram illustrating an exemplary format of map information stored in a map database;

FIG. 3 is a diagram illustrating exemplary feature information associated with a road marking stored in a feature database;

FIG. 4 is a diagram illustrating an exemplary position at which an image pickup apparatus is installed on a vehicle;

FIGS. 5A to 5C illustrate an exemplary learning process on feature information on the basis of a result of image recognition of a particular feature;

FIG. 6 is a diagram illustrating a main part of FIG. 5B in an enlarged manner as to learned values stored in a learned database;

FIG. 7A is a diagram illustrating a specific example of a behavior of a vehicle;

FIG. 7B illustrates an example of a content of detected behavior information associated with the behavior shown in FIG. 7A;

FIG. 7C illustrates an example of a content of learned behavior information;

FIG. 8 is a flow chart illustrating an exemplary behavior learning method;

FIG. 9 is a flow chart illustrating an exemplary feature learning method;

FIG. 10 is a flow chart illustrating an exemplary behavior prediction method;

FIG. 11 is a diagram schematically illustrating an example of a manner in which a vehicle behavior is learned on the basis of a trajectory of vehicle position information;

FIG. 12 is a diagram schematically illustrating an example of a manner in which a result of vehicle behavior prediction is used in displaying a vehicle position mark; and

FIG. 13 is a diagram illustrating an exemplary system in which a part of a vehicle behavior learning apparatus is disposed in a server.

### DETAILED DESCRIPTION OF EXEMPLARY IMPLEMENTATIONS

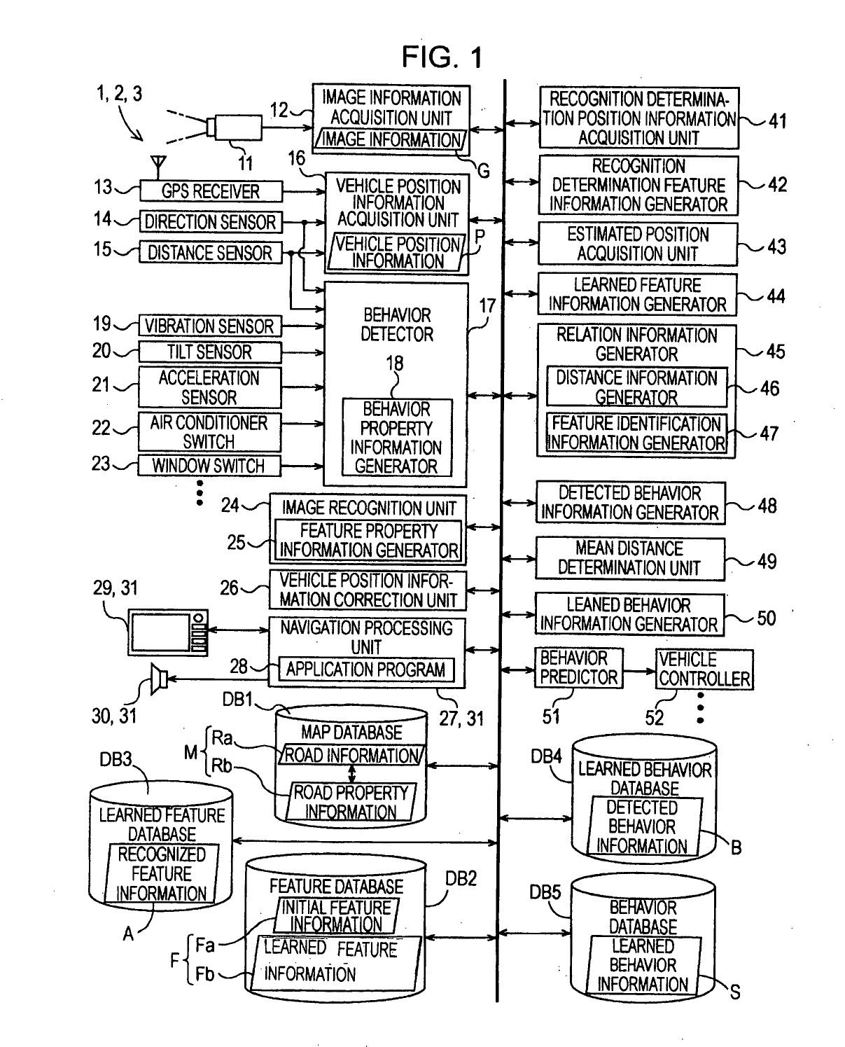

FIG. 1 is a block diagram schematically illustrating a configuration of a navigation apparatus 1. As shown in FIG. 1, the navigation apparatus 1 according to the present example includes a vehicle behavior learning apparatus 2 and a vehicle position recognition apparatus 3. The navigation apparatus 1 is adapted to detect a behavior of a vehicle C in which the present navigation apparatus 1 is installed, and learn the behavior of the vehicle C in relation to a particular feature detected via image recognition performed before the detection of the behavior. On the basis of the result of the learning on the behavior of the vehicle C, a prediction is made on the behavior of the vehicle C that will occur when the same particular feature is detected via the image recognition, and the vehicle is controlled properly depending on the prediction. The navigation apparatus 1 is also adapted to learn feature information F including the position of the particular feature and a feature property, on the basis of the result of the image recognition of the particular feature.

Blocks in the navigation apparatus 1 shown in FIG. 1 physically, functionally, and/or conceptually includes units adapted to perform various processes on data input thereto by a processing apparatus such as a CPU. These units may be implemented by hardware and/or software (a computer-readable program) executed by a controller. The functional units are adapted to communicate with each other. Databases DB1 to DB5 in the navigation apparatus 1 are implemented using a hardware apparatus including a storage medium capable of storing information and a drive thereof such as a hard disk drive, a DVD drive with a DVD-ROM disk, or a CD drive with a CD-ROM disk.

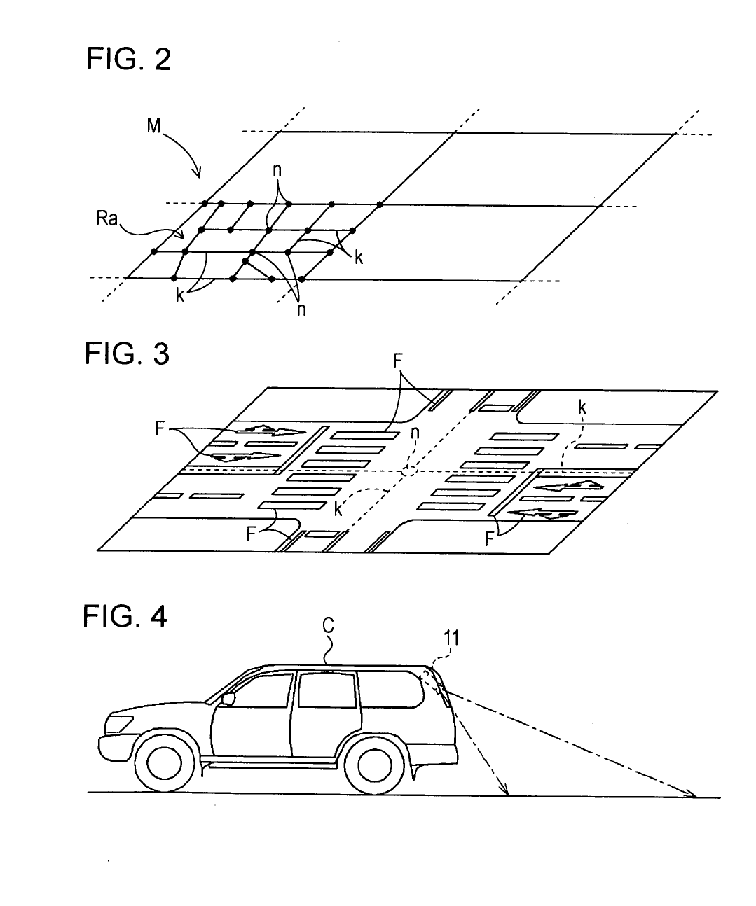

The map database DB1 is a database in which map information M associated with each of many areas is described. FIG. 2 illustrates an example of map information M stored in the map database DB1. As shown in FIG. 2, the map information M includes nodes n corresponding to intersections and road information Ra representing a road network by a connection relationship between nodes n and links k corresponding to roads connecting between intersections. Each node n has information indicating the position (e.g., coordinates on a map expressed in latitude and longitude). Each link k is connected to another link via a node n. Each link k has property information indicating a road type, a link length, a road width, a shape interpolation point for representing a link shape, and the like. The road type information indicates the road type classifying the link of interest, such as an automobile road, a city road, a narrow street, or a mountain path. The property information of the link k corresponds to as road property information Rb. Note that in FIG. 2, road information Ra is shown only for one area, although each of other areas has its own road information Ra.

The feature database DB2 is a database in which information about various kinds of features disposed on or near roads is stored. In other words, the feature database DB2 is a database in which feature information F is stored. As shown in FIG. 1, in the present example, two kinds of information, i.e., initial feature information Fa and learned feature information Fb are stored in the feature database DB2. The initial feature information Fa is feature information F associated with a plurality of features stored in advance in the feature database DB2. Such initial feature information Fa is available only for particular roads such as main roads in particular areas such as large cities, among the various areas for which map information M including road information Ra is available. In contrast, the learned feature information Fb is feature information F that is produced by a learned feature information generator 44 on the basis of information obtained via image recognition of particular features performed by an image recognition unit 24 and that is stored in the feature database DB2. Hereinafter, the term “feature information F” is used to generically describe feature information including initial feature information Fa and learned feature information Fb.

The feature information F stored in the feature database DB2 includes information about road markings (e.g., paint markings) on road surfaces. FIG. 3 illustrates examples of feature information F in terms of road markings stored in the feature database DB2. Specific examples of features associated with road markings include pedestrian crossings, stop-lines, speed limit signs indicating a maximum speed limit or the like, zebra zones, white lines (such as solid white lines, broken white lines, double white lines, and the like) indicating boundaries between adjacent lanes, and marks indicating allowed running directions (for example, an arrow instructing that vehicles should run straight ahead, an arrow instructing that vehicles should turn right, and the like). The features stored as feature information F may further include traffic signals, traffic signs, land bridges, tunnels, and the like.

The feature information F includes position information of each feature and feature property information associated with the feature. The position information includes information indicating the position (e.g., coordinates) on map of a representative point of each feature related to a link k or a node n described in the road information Ra and also includes information indicating the orientation of each feature. For example, the representative point may be set at substantially the middle, in both longitudinal and lateral directions, of each feature. The feature property information includes identification information (feature ID) identifying each feature from the other features, and type information indicating the feature type of each feature or feature shape information indicating the shape, the size, the color, or the like, of the feature. The feature type is information indicating a feature type classified by shapes, such as a “pedestrian crossing,” a “stop-line,” a “speed limit sign (e.g., 30 km/hours),” and the like.

Preferably, the feature information F may include feature relation information indicating a relationship with another nearby feature, and distance-to-feature information indicating the distance to that other feature. The feature relation information is used, for example, to predict another feature existing ahead of a present feature detected via image recognition when the vehicle C is running on a road. The distance-to-feature information is used to predict the precise distance from the vehicle C to the feature existing ahead.

The learned feature database DB3 is a database in which recognized feature information A produced by a recognized feature information generator 42 (described later) is stored. In this learned feature database DB3, recognized feature information A associated with each of a plurality of particular features successfully recognized by the image recognition unit 24 is stored. The specific content of the recognized feature information A stored in the learned feature database DB3 will be described in detail later.

The learned behavior database DB4 is a database in which detected behavior information B produced by the detected behavior information generator 48 (described later) is stored. In this learned behavior database DB4, detected behavior information B associated with each of a plurality of behaviors detected by a behavior detector 17 is stored. Specific contents of the detected behavior information B stored in the learned behavior database DB4 will be described in detail later.

A behavior database DB5 is a database in which learned behavior information S produced by a learned behavior information generator 50 (described later) is stored. In the behavior database DB5, learned behavior information S associated with each of a plurality of behaviors detected by a learned behavior detector 17 is stored. Specific contents of the learned behavior information S stored in the behavior database DB5 will be described in detail later.

An image information acquisition unit 12 is adapted to acquire image information G of the vicinity of the vehicle taken by the image pickup apparatus 11. The image pickup apparatus 11 is an in/on-vehicle camera or the like having an image sensor, and is installed at a position that allows the image pickup apparatus 11 to take an image of at least a surface of a road in the vicinity of the vehicle C. For example, a rear-view camera adapted to take an image of a road surface behind the vehicle C as shown in FIG. 4 may be preferably used as for the image pickup apparatus 11 for the above purpose. The image information acquisition unit 12 captures image information output from the image pickup apparatus 11 via a frame memory (not shown) or the like at predetermined time intervals. The time intervals at which to capture the image information G may be set, for example, to a value in the range from 10 to 50 ms. The image information acquisition unit 12 is adapted to continuously capture a plurality of frames of image information G output from the image pickup apparatus 11. The acquired image information G is supplied to the image recognition unit 24.

### Vehicle Position Information Acquisition Unit

A vehicle position information acquisition unit 16 is adapted to acquire vehicle position information P indicating the current position of the vehicle C. The vehicle position information acquisition unit 16 is connected to a GPS receiver 13, a direction sensor 14, and a distance sensor 15. The GPS receiver 13 is adapted to receive GPS signals transmitted from GPS (Global Positioning System) satellites. The GPS signals are received at intervals of 1 second and supplied to the vehicle position information acquisition unit 16. In the vehicle position information acquisition unit 16, the signals from the GPS satellites are analyzed to acquire information about the current position (e.g., coordinates), the running direction, the running speed, and the like, of the vehicle C.

The direction sensor 14 is a sensor adapted to detect the running direction or a change in the running direction of the vehicle C. The direction sensor 14 may be implemented using, for example, a gyroscope, a geomagnetic sensor, an optical rotation sensor or a rotary potentiometer installed on a rotating part of a steering wheel, or an angle sensor installed on a wheel part. The direction sensor 14 supplies a detection result to the vehicle position information acquisition unit 16. The distance sensor 15 is a sensor adapted to detect the vehicle speed or the travel distance of the vehicle C. The distance sensor 15 is implemented using, for example, a vehicle speed pulse sensor adapted to output a pulse signal each time a drive shaft or a wheel of a vehicle rotate a predetermined amount, or a combination of a yaw/G sensor adapted to sense the acceleration of the vehicle C and a circuit adapted to determine the integral of the acceleration. The distance sensor 15 outputs information indicating the detection result of the vehicle speed and the travel distance to the vehicle position information acquisition unit 16. In the present example, the direction sensor 14 and the distance sensor 15 supplies the detection results also to the behavior detector 17.

Based on the information supplied from the GPS receiver 13, the direction sensor 14, and/or the distance sensor 15, the vehicle position information acquisition unit 16 calculates the vehicle position according to a known technique. Furthermore, the vehicle position information acquisition unit 16 acquires road information Ra associated with a nearby area around the vehicle position by reading the road information Ra from the map database DB1, and performs map matching using the acquired road information Ra according to a known technique to correct the vehicle position such that the vehicle position is correctly located on a road represented by the road information Ra. As described above, the vehicle position information acquisition unit 16 acquires information about the current position of the vehicle C and vehicle position information P including information indicating the running direction of the vehicle C.

The behavior detector 17 functions as a behavior detection unit adapted to detect the behavior of the vehicle C. As shown in FIG. 1, the behavior detector 17 detects the behavior of the vehicle C on the basis of signals output from various kinds of sensors and switches disposed in various parts of the vehicle C. Examples of sensors that supply the signals to the behavior detector 17 are, in addition to the direction sensor 14 and the distance sensor 15 described above, a vibration sensor 19, a tilt sensor 20, an acceleration sensor 21, an accelerator sensor (not shown), a brake sensor (not shown), and a luminance sensor (not shown). Examples of various switches that output signals to the behavior detector 17 are an air-conditioner switch 22, a window switch 23, a headlight control switch (not shown), an audio control switch (not shown), a display/input unit 29 having a navigation control touch panel, and a remote controller (not shown).

The vibration sensor 19 is a sensor adapted to detect vibrations of a body of the vehicle C. The result of the detection performed by the vibration sensor 19 is used, for example, in controlling active suspension. The tilt sensor 20 is a sensor adapted to detect the tilt of the body of the vehicle C. From the result of the detection performed by the tilt sensor 20, it is possible to detect the tilt of a road on which the vehicle C is running. The acceleration sensor 21 is a sensor adapted to detect the acceleration or deceleration of the vehicle C. The accelerator sensor is a sensor adapted to detect the operation amount on the accelerator pedal performed by a driver. The brake sensor is a sensor adapted to detect the operation amount on the brake pedal performed by the driver or the force applied to the brake pedal. The luminance sensor is a sensor adapted to detect the brightness in the outside of the vehicle C thereby to automatically control the headlight.

The air-conditioner switch 22 is a switch used to set a target temperature of the air conditioner and select an the operation mode between a mode in which external air is inhaled and a mode in which air is circulated internally. The window switch 23 is a switch used to open/close a window. The headlight control switch is a switch used to turn on/off the headlight and to switch the mode between a high beam mode and a low beam mode. The audio control switch is a switch to control audio parameters such as a sound volume and to control a playback operation. The navigation display/input unit 29 and the remote controller (not shown) include a switch used to input a command to a navigation processing unit 27 in the navigation apparatus 1.

In the present example, the behaviors detected by the behavior detector 17 include any detectable characteristic behavior of the vehicle C. Examples of behaviors are operations performed by a driver at various parts of the vehicle C and operations of the vehicle C. The operations of the vehicle C include operations of various parts of the vehicle C or operations of the vehicle C as a whole that occur in response to operations performed by the driver, and operations of various parts of the vehicle C or operations of the vehicle C as a whole that occur due to an external factor applied from the outside to the vehicle C. For example, operations of various switches including the air-conditioner switch 22, the window switch 23, the headlight control switch (not shown), the audio control switch (not shown), and the navigation display/input unit 29 or the navigation remote controller (not shown), and operations performed by the driver detected by various sensors such the accelerator sensor and the brake sensor are detected by the behavior detector 17 as behaviors which occur due to acceptance, at various parts of the vehicle C, of operations performed by the driver.

For example, a change in the running direction of the vehicle C detected by the direction sensor 14 from a steering operation performed by a driver, a change in the acceleration of the vehicle C detected by the acceleration sensor 21 from an operation of an accelerator pedal or a brake pedal performed by the driver, a change in gear of a transmission performed by a shift operation or an accelerator operation performed by the driver, and the like are operations of the vehicle C which occur as a result of corresponding operations performed by the driver and which are detected by various sensors, and these operations are detected by the behavior detector 17 as behaviors of the vehicle C due to operations performed by the driver. For example, the operation of the navigation processing unit 27 in response to a driver's operation of the remote controller (not shown) or the touch panel of the navigation display/input unit 29 is also detected by the behavior detector 17 as a behavior of the vehicle C due to the operation performed by the driver. Specific examples of operations of the navigation processing unit 27 include acquisition of congestion information, change in scale of a map, change in brightness of a display screen, change in navigation route, and the like, which are performed in response to an operation performed by a driver.

For example, a vibration of or a shock on the vehicle C detected by the vibration sensor 19, which may occur when the vehicle C runs on a road having a rough surface or a step, a change in the acceleration of the vehicle C detected by the tilt sensor 20 and the acceleration sensor 21, which may occur when the vehicle C runs on a sloping road, a change in the running direction of the vehicle C detected by the direction sensor 14, which may occur when the vehicle C runs along a curve, and the like, are operations of the vehicle C, which occur due to external factors and which are detected by various sensors, are detected by the behavior detector 17 as behaviors of the vehicle C due to external factors. Note that driver-driven operations of the vehicle C and external-factor-driven operations of the vehicle C are not always strictly distinguishable from each other, but there are operations that belong to both types of operations.

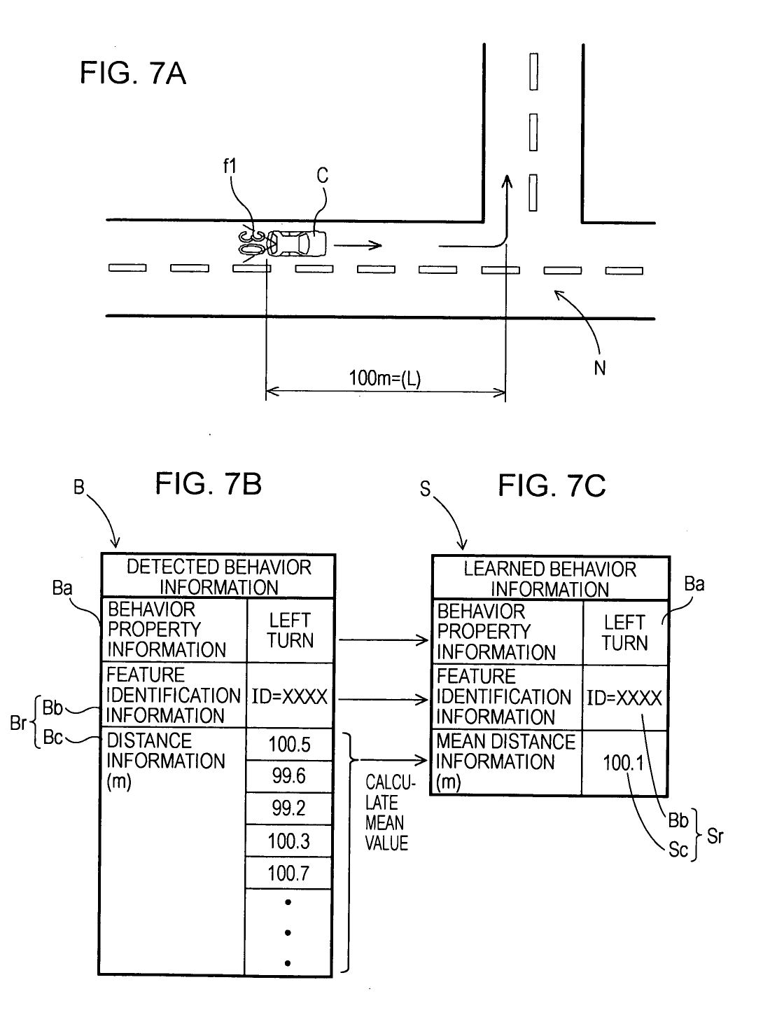

In the present example, the behavior detector 17 includes a behavior property information generator 18. The behavior property information generator 18 functions as the behavior property information generation unit adapted to produce behavior property information Ba (see FIG. 7) indicating the property of a behavior detected by the behavior detector 17. As described later, the behavior property information Ba is part of detected behavior information B and learned behavior information S. The property of the behavior represented by the behavior property information Ba is information identifying the content and the type of the behavior detected by the behavior detector 17 to distinguish the behavior from the other behaviors. Thus, for example, the behavior property information Ba is described as follows.

The behaviors classified by the behavior property information Ba as behaviors due to acceptance of operation performed by a driver include, for example, “switching of an air conditioner from a mode in which air is inhaled from the outside to a mode in which air is circulated internally,” “opening of a window on the driver's side,” “switching of headlights from a low-beam mode to a high-beam mode,” and “shift-down operation of a shift level.” The behaviors classified by the behavior property information Ba as behaviors of the vehicle C due to operation performed by a driver include, for example, “making a left turn,” “making a right turn,” “making a left turn along a curve,” “making a right turn along a curve,” “accelerating,” “decelerating,” “stopping,” “shifting down transmission,” “changing the scale of a map displayed on the navigation apparatus,” and “changing the navigation route of the navigation apparatus.” The behaviors classified by the behavior property information Ba as behaviors of the vehicle C due to external factors include, for example, “vibration,” “shock-induced movement,” “running uphill,” and “running downhill.” Examples of behaviors due to external factors and operations performed by a driver are “making a left turn along a curve,” “making a right turn along a curve,” “accelerating,” and “decelerating.” Note that the content of the behavior property information Ba is not limited to the examples described above, but the property of the behavior represented by the behavior property information Ba may be determined as needed to classify behaviors.

The image recognition unit 24 is adapted to perform image recognition of a particular feature included in the image information G acquired by the image information acquisition unit 12. In the present example, the image recognition unit 24 performs image recognition of road markings as a particular feature disposed on the surface of roads. Specifically, in the image recognition of a particular feature, the image recognition unit 24 extracts outline information of the particular feature included in the image information G by performing a binarization process or an edge detection process on the image information G. Thereafter, the image recognition unit 24 performs a pattern matching process on the extracted outline information of the feature with respect to feature values of shapes of various features which can be the particular feature whereby image recognition unit 24 extracts an image of the particular feature included in the image information G.

Furthermore, the image recognition unit 24 detects the feature type of the feature having the feature value that matches the feature value of the extracted outline information of the feature, and recognizes the detected feature type as the feature type of the particular feature included in the image information G. In the case where the pattern matching was successful, the image recognition unit 24 determines that the image recognition of the particular feature has been performed successfully. On the other hand, when the pattern matching in the image recognition of the image information G was not successful, the image recognition unit 24 determines that the image recognition of the particular feature has failed.

In the present example, the image recognition unit 24 includes a feature property information generator 25. The feature property information generator 25 functions as a unit adapted to produce feature property information representing the property of the particular feature recognized by the image recognition unit 24. As described later, the feature property information is part of recognized feature information A and learned feature information Fb. The property of the particular feature represented by the feature property information may be any property that distinguishes the particular feature from other features. Thus, the feature property information has information representing one or more of the following: a feature type of the present particular feature; a specific shape and/or a size of the particular feature; a link ID of a link k on which the particular feature exists; and a rough position of the particular feature. Each piece of information included in the feature property information is produced on the basis of a result of image recognition of the particular feature performed by the image recognition unit 24, the vehicle position information P indicating the position of the vehicle as of the acquisition time of the image information G from which the particular feature was recognized, and the like.

A vehicle position information correction unit 26 is adapted to correct the vehicle position information P on the basis of the result of the image recognition of the particular feature performed by the image recognition unit 24 and the feature information F associated with the particular feature stored in the feature database DB2. In the present example, first, the vehicle position information correction unit 26 calculates the positional relationship between the vehicle C and the particular feature as of the time of the acquisition of the image information G including the image of the particular feature, on the basis of the result of the image recognition performed by the image recognition unit 24 and the installation position, the installation angle, and the view angle of the image pickup apparatus 11. The vehicle position information correction unit 26 then extracts the feature information F associated with the particular feature recognized by the image recognition unit 24 from the feature database DB2.

Thereafter, on the basis of the result of the calculation of the positional relationship between the vehicle C and the particular feature and the position information associated with the particular feature included in the feature information F associated with the particular feature, the vehicle position information correction unit 26 calculates precise position information of the vehicle C with respect to the position information (feature information F) associated with the particular feature in the running direction of the vehicle C. On the basis of the high-precision position information of the vehicle C acquired in the above-described manner, the vehicle position information correction unit 26 corrects the information included in the vehicle position information P acquired by the vehicle position information acquisition unit 16 so as to correctly indicate the current position of the vehicle C in the running direction. Thus, the vehicle position information acquisition unit 16 acquires the high-precision vehicle position information P corrected in the above-described process.

The navigation processing unit 27 is adapted to operate according to the application program 28 to perform a navigation function such as displaying a vehicle position, searching for a route from a starting point to a destination, providing route guidance to the destination, and searching for a destination. According to the application program 28, the navigation processing unit 27 executes various navigation functions while referring to the vehicle position information P, the map information M, the learned behavior information S, and the feature information F. For example, the navigation processing unit 27 acquires map information M associated of a nearby area around the vehicle C from the map database DB1 in accordance with the vehicle position information P and displays a map image on the display screen of the display/input unit 29. Furthermore, the navigation processing unit 27 displays a vehicle position mark superimposed on the map image in accordance with the vehicle position information P.

In the above-described process, the application program 28 controls the behavior prediction unit 51 (described later) to predict the behavior of the vehicle C such as a right turn, a left turn, or the like on the basis of the learned behavior information S thereby making it possible to correctly display a vehicle position mark at a correction point where the vehicle C is actually located, without having a matching error. The navigation processing unit 27 searches for a route from a specified staring point to a destination on the basis of the map information M stored in the map database DB1. The navigation processing unit 27 provides route guidance to a driver using one or both of the display/input unit 29 and audio output unit 30 in accordance with the route, detected in the searching process, from the staring point to the destination and in accordance with the vehicle position information P.

The display/input unit 29 is a unit constructed in an integrated form including a display device such as a liquid crystal display device and an input device such as a touch panel or operation control switches. The audio output unit 30 is implemented using a speaker. In the present example, the navigation processing unit 27, the display/input unit 29, and the audio output unit 30 function, as a whole, as the guidance information output unit 31.

A recognition position information acquisition unit 41 is adapted to acquire recognition position information indicating a recognition position of a particular feature successfully recognized via the image recognition performed by the image recognition unit 24. In the present example, the recognition position information acquisition unit 41 monitors whether a particular feature is successfully detected via the image recognition process performed by the image recognition unit 24. If a particular feature is successfully detected via the image recognition performed by the image recognition unit 24, the recognition position information acquisition unit 41 determines the recognition position of the particular feature on the basis of the result of the image recognition and the vehicle position information P acquired by the vehicle position information acquisition unit 16. Specifically, the recognition position information acquisition unit 41 acquires the vehicle position information P at the time at which the image information G including the image of the successfully recognized particular feature is acquired, and employs this acquired vehicle position information P as the recognition position information of the particular feature. Because the recognition position information of the particular feature is determined on the basis of the vehicle position information P, the recognition position information may have an error included in the vehicle position information P.

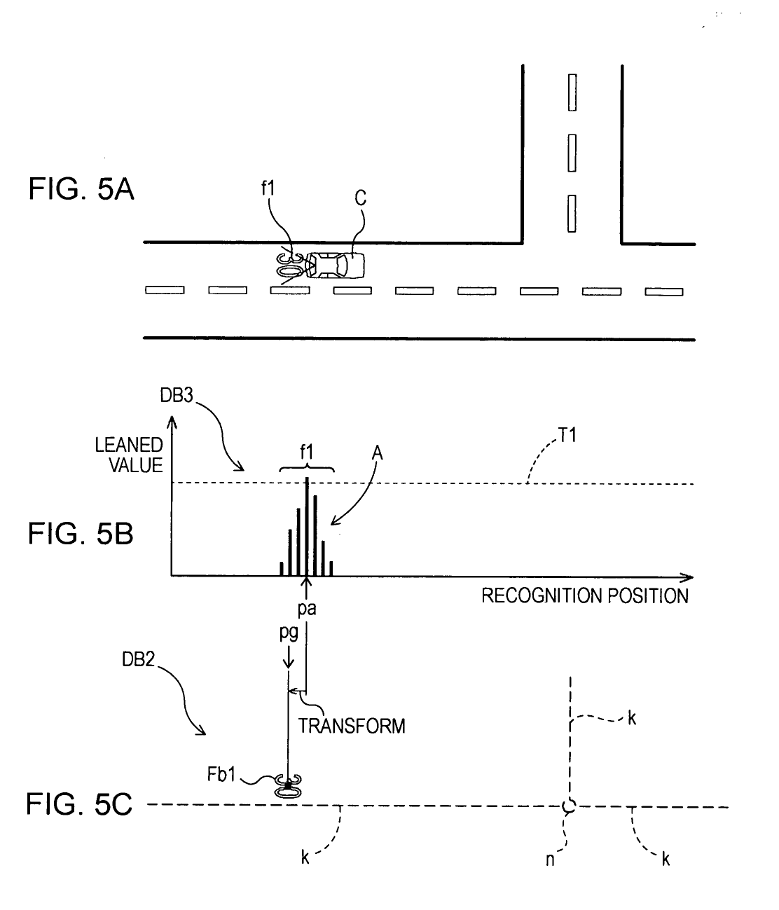

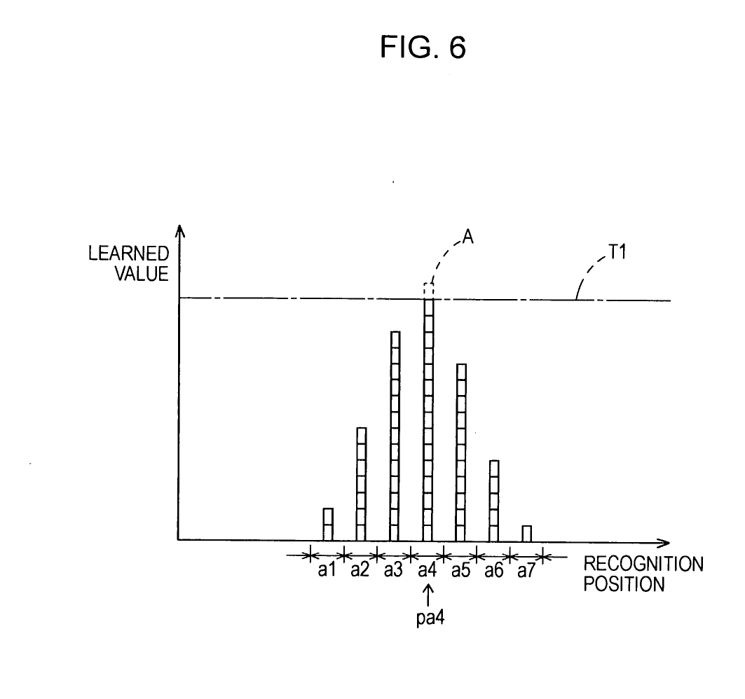

The recognized feature information generator 42 is adapted to produce recognized feature information A associated with the particular feature successfully recognized via the image recognition performed by the image recognition unit 24. The recognized feature information A includes the feature property information of the particular feature produced by the feature property information generator 25 and the recognition position information of the particular feature acquired by the recognition position information acquisition unit 41. The recognized feature information generator 42 stores the produced recognized feature information A in the learned feature database DB3. An example of the process performed by the recognized feature information generator 42 is described below with reference to FIGS. 5 and 6.

FIGS. 5A to 5C are diagrams provided for an explanation of the outline of the learning process on the feature information F on the basis of the result of image recognition of a particular feature. FIG. 5A illustrates an example of a road marking (an example of a particular feature) formed on a road on which the vehicle C runs. In this specific example, the image recognition unit 24 performs image recognition on characters “30” of the speed limit sign as a particular feature f1. FIG. 5B illustrates an example of recognized feature information A stored in the learned feature database DB3. FIG. 5C illustrates an example of data stored in the feature database DB2, the data being modified according to the learning result stored in the learned feature database DB3.

In the present example, as shown in FIG. 5B, on the basis of the recognition position information acquired by the recognition position information acquisition unit 41, the recognized feature information generator 42 produces recognized feature information A associated with each particular feature as learned values in a range within which recognition positions of the particular feature indicated by the recognition position information falls. Each time the particular feature is recognized, the recognized feature information generator 42 adds the learned value individually for each position range and stores the result. In the present example, the position range is a road segment defined along a link k corresponding to a particular road and having a predetermined length. For example, each position range is defined to have a length of 0.5 meters along a link k. The learned value is a value which is added, each time one particular feature is successfully detected via the image recognition, to the position range to which the recognition position of the particular feature belongs, in the learned feature database DB3. Specifically, for example, each time one particular feature is successfully detected via the image recognition, one point is added. That is, in the present example, the recognized feature information A includes the recognition position information of particular feature, i.e., information indicating the position range in which the recognition position of the particular feature falls, and also include information indicating the learned value “1” thereof.

FIG. 6 illustrates, an enlarged part of FIG. 5B in terms of a learned value associated with the particular feature f1 stored in the learned feature database DB3. In the example shown in FIG. 5A, when the particular feature f1 is successfully recognized via the image recognition, if the recognition position of the particular feature f1 acquired by the recognition position information acquisition unit 41 is within, for example, a position range represented by “a4” in FIG. 6, then “1” is added to the learned value of the position range a4 as represented by a broken line in FIG. 6. If the same road is traveled by the vehicle C a plurality of times, and thus the same particular feature f1 is recognized the plurality of times via the image recognition, then, as shown in FIG. 5B and FIG. 6, the plurality of pieces of recognized feature information A indicating learned values are accumulated in the learned feature database DB3 in such a manner that learned values are grouped into the position ranges according to the recognition positions of the particular feature. If the learned value reaches a value greater than a predetermined learning threshold value T1, learned feature information Fb associated with the particular feature is produced by the learned feature information generator 44 and is stored in the feature database DB2. In the example shown in FIG. 5C, learned feature information Fb1 associated with the particular feature f1 is stored in the feature database DB2.

In order to identify the particular feature indicated by the recognized feature information A so as to distinguish it from the other particular features, the recognized feature information has feature property information of the particular feature produced by the feature property information generator 25. That is, the recognized feature information A stored in the learned feature database DB3 includes recognition position information indicating the position range of the particular feature and information indicating the learned value “1” thereof, and the recognized feature information A is related to feature property information indicating the feature property of the particular feature. As described above, the feature property information includes one or more pieces of information selected from the feature type of the particular feature, the shape and the size of the particular feature, the link ID of the link k on which the particular feature exists, and a roughly expressed position of the particular feature.

An estimated position acquisition unit 43 is adapted to obtain estimated position information associated with each particular feature statistically determined from a plurality of pieces of recognition position information associated with the particular feature stored in the learned feature database DB3. Specifically, the estimated position acquisition unit 43 reads, from the learned feature database DB3, a plurality of pieces of recognized feature information A associated with the same particular feature detected a plurality of times via the image recognition, and the estimated position acquisition unit 43 determines the estimated recognized position pa of the particular feature as shown in FIG. 5B. The estimated position acquisition unit 43 then converts the estimated recognized position pa into a position on a road thereby obtaining an estimated position pg of the particular feature.

Specifically, in the present example, first, the estimated position acquisition unit 43 determines the representative value of the distribution of the plurality of pieces of recognized feature information A associated with the sane particular feature, and employs the determined representative as the estimated recognized position pa of the particular feature. In the present example, the mode is employed as the representative value of the distribution. That is, the estimated position acquisition unit 43 detects a learned value expressed as recognized feature information A associated with a particular feature which reaches a value equal to or greater than a predetermined threshold value T1 earliest at a position among all positions, and the estimated position acquisition unit 43 employs this position as the estimated recognized position pa of the particular feature.

As one example, a method of determining the estimated recognized position pa of the particular feature f1 shown in FIGS. 5A to 5C is described below. As shown in FIG. 6, learned values expressed as recognized feature information A associated with the particular feature f1 exceed the learning threshold value T1 in the position range a4 earliest among all position ranges. Thus, the estimated position acquisition unit 43 employs the representative position of the position range a4, for example, the central position pa4 of the position range a4, as the estimated recognized position pa of the particular feature f1.

The estimated position acquisition unit 43 then converts the estimated recognized position Pa of the particular feature determined in the above-described manner into a position of the particular feature on a road and employs the resultant position as the estimated position pg of the particular feature. The conversion may be performed on the basis of the positional relationship between the vehicle C and the particular feature in the image information G, theoretically determined from the installation, the installation angle, and the view angle of the image pickup apparatus 11. Information indicating the estimated position pg of the particular feature determined in the above-described manner by the estimated position acquisition unit 43 is acquired as the estimated position information associated with the particular feature.

The learned feature information generator 44 functions as the learned feature information generation unit adapted to produce learned feature information Fb indicating a result of learning on the particular feature on the basis of a plurality of pieces of recognized feature information A associated with the same particular feature produced via image recognition performed for the same particular feature a plurality of times and stored in the learned feature database DB3. The learned feature information Fb includes feature property information associated with the same particular feature as that indicated in the plurality of pieces of recognized feature information A and also includes the estimated position information indicating the estimated position pg of the particular feature determined by the estimated position acquisition unit 43 by statistically processing the plurality of pieces of recognition position information A associated with the particular feature.

That is, the learned feature information generator 44 produces the learned feature information Fb so as to relate the estimated position information indicating the estimated position pg acquired by the estimated position acquisition unit 43 for each particular feature to the feature property information included in the recognized feature information A associated with the particular feature. In the production of the learned feature information Fb, the learned feature information generator 44 attaches identification information (feature ID) as one of items of feature property information to each learned feature information Fb to distinguish each feature from the other features. Thus, as with the initial feature information Fa, the learned feature information Fb includes position information and associated feature property information. The learned feature information Fb produced by the learned feature information generator 44 is stored in the feature database DB2. In the specific example shown in FIG. 5C, the learned feature information Fb1 is produced by the learned feature information generator 44 and stored in the feature database DB2. Note that in FIG. 5C, a solid square indicates the estimated position pg of the particular feature f1 represented by the position information of the learned feature information Fb1.

A relation information generator 45 functions as a unit adapted to acquire relation information Br (FIG. 7B) such that when a behavior of the vehicle C is detected by the behavior detector 17, the relation information generator 45 produces relation information Br indicating the relationship between the detected behavior of the vehicle C and the particular feature recognized by the image recognition unit 24 before the detection of the behavior. Note that the relation information generator 45 acquires the relation information Br on the basis of at least one of information provided by the distance sensor 15 serving as the travel distance detection unit adapted to detect the travel distance of the vehicle C and information provided by the vehicle position information acquisition unit 16 adapted to acquire the vehicle position information P indicating the current position of the vehicle C. To this end, in the present example, as shown in FIG. 1, the relation information generator 45 has a distance information generator 46 and a feature identification information generator 47. The process performed by the distance information generator 46 and the process performed by the feature identification information generator 47 are described in detail below.

Referring to FIGS. 7A to 7C, a specific example of detected behavior information B associated with a behavior of the vehicle C and a specific example of a content of learned behavior information S are described. FIG. 7A illustrates a specific example of a road on which the vehicle C runs. In the example shown in FIG. 7A, after the vehicle C passes over the particular feature f1 of a maximum speed limit sign “30,” the vehicle C travels 100 meters, and then the vehicle C makes a left turn at an intersection N. Thus, in this specific example, the behavior detector 17 detects the “left turn” as a behavior of the vehicle C at the intersection N when the vehicle C has traveled 100 meters after the image recognition unit 24 detected the particular feature f1 via the image recognition. FIG. 7B illustrates an example of detected behavior information B associated with this behavior, and FIG. 7C illustrates an example of learned behavior information S associated with the behavior.

The distance information generator 46 functions as a unit adapted to produce distance information Bc indicating the distance from the recognition position of the particular feature recognized by the image recognition unit 24 to the position at which the behavior of the vehicle C was detected by the behavior detector 17. Specifically, as shown in FIG. 7A, after the image recognition unit 24 detects a particular feature f1 via the image recognition, if the behavior detector 17 detects a behavior of the vehicle C, then the distance information generator 46 determines the distance from the particular feature recognition position to the behavior detection position and produces distance information Bc indicating the detected distance. Hereinafter, the particular feature recognition position to the behavior detection position will be referred to simply as the feature-behavior distance. For the above purpose, in the present example, the distance information generator 46 uses the travel distance of the vehicle C detected by the distance sensor 15 to determine the feature-behavior distance L.

Specifically, on the basis of the information output from the distance sensor 15, the distance information generator 46 detects the distance from the position of the vehicle C when the particular feature was detected by the image recognition unit 24 to the position of the vehicle C when the behavior of the vehicle C was detected, and the distance information generator 46 determines the detected distance as the feature-behavior distance L. By using the information output from the distance sensor 15, it is possible to detect the feature-behavior distance L without using the vehicle position information P. The distance information generator 46 produces distance information Bc indicating the detected feature-behavior distance L. In the specific example shown in FIG. 7A, the feature-behavior distance L is detected as 100 meters. Note that the distance information Bc indicating the feature-behavior distance L, produced by the distance information generator 46 on the basis of the information output from the distance sensor 15, includes any error of the distance sensor 15 as shown in FIG. 7B.

The feature identification information generator 47 functions as a unit adapted to produce feature identification information Bb identifying the particular feature recognized by the image recognition unit 24. Specifically, as in the example shown in FIG. 7A, when a behavior of the vehicle C is detected by the behavior detector 17 after the recognition of the particular feature f1 by the image recognition unit 24, the feature identification information generator 47 produces feature identification information Bb identifying the recognized particular feature f1. In the present example, the feature identification information Bb is given by identification information pointing to recognized feature information A stored in the learned feature database DB3 (in the example shown in FIG. 7B, the feature identification information Bb is given as “ID=XXXX”). Specifically, after the recognition of the particular feature f1 by the image recognition unit 24, when the recognized feature information A associated with the recognized particular feature f1 is produced by the recognized feature information generator 42 and stored in the learned feature database DB3, the feature identification information generator 47 acquires the identification information identifying the recognized feature information A, and produces the feature identification information Bb by employing the acquired identification information as the feature identification information Bb. Thus, by referring to the recognized feature information A stored in the learned feature database DB3 on the basis of the feature identification information Bb included in the detected behavior information B or the learned behavior information S, it is possible to identify the feature property and the recognition position of the particular feature indicated by the detected behavior information B or the learned behavior information S.

The identification information identifying the recognized feature information A stored in the learned feature database DB3 is not limited to the feature ID assigned to the each recognized feature information A, but other information may be used as long as the information correctly identifies the recognized feature information A. For example, information indicating the storage location of each recognized feature information A in the learned feature database DB3 may be used as the identification information.

In the present example, as shown in FIG. 7B, the relation information Br is produced so as to include the distance information Bc produced by the distance information generator 46 and the feature identification information Bb produced by the feature identification information generator 47.

The detected behavior information generator 48 functions as the detected behavior information generation unit adapted to produce detected behavior information B including the behavior property information Ba indicating the property of the behavior of the vehicle C detected by the behavior detector 17 and the relation information Br associated with the behavior acquired by the relation information generator 45. In the present example, as described above, the behavior property information Ba is produced by the behavior property information generator 18 when the behavior of the vehicle C is detected by the behavior detector 17. The distance information Bc and the feature identification information Bb included in the relation information Br are produced by the distance information generator 46 and the feature identification information generator 47 of the relation information generator 45. The detected behavior information generator 48 produces the detected behavior information B so as to relate the behavior property information Ba to the relation information Br. The detected behavior information generator 48 stores the produced detected behavior information B in the learned behavior database DB4.

When there are a plurality of pieces of detected behavior information B associated with the same behavior, the property of the behavior and the particular feature detected via the image recognition before the detection of the behavior are the same for all pieces of detected behavior information B. Therefore, in the present example, for a plurality of pieces of detected behavior information B associated with the same behavior, the detected behavior information generator 48 produces a set of detected behavior information B including a single piece of behavior property information Ba and a single piece of feature identification information Bb and stores the set of detected behavior information B in the learned behavior database DB4. FIG. 7B illustrates an example in which a plurality of pieces of detected behavior information B associated with the same behavior (“left turn”) in the example shown in FIG. 7A are stored as a single set. In this example, the detected behavior information B includes a plurality of pieces of distance information Bc all of which are related to a single piece of behavior property information Ba of a behavior “left turn” and a single piece of feature identification information Bb having identification information “ID=XXXX.” Because each of the plurality of pieces of distance information Bc includes a detection error of the distance sensor 15, values are slightly different from each other, although the values are nearly equal to the actual feature-behavior distance L, i.e., 100 meters.

A mean distance determination unit 49 determines the mean value of a plurality of pieces of distance information Bc associated with the same behavior indicated in a plurality of pieces of detected behavior information B associated with the same behavior, and produces mean distance information Sc indicating the mean value. In the present example, the mean distance determination unit 49 determines the mean value for a plurality of pieces of distance information Bc of detected behavior information B stored as a single set including common behavior property information Ba and feature identification information Bb. The mean distance determination unit 49 produces mean distance information Sc indicating the determined mean value of the plurality of pieces of distance information Bc associated with the same behavior.

In the example of learned behavior information S shown in FIG. 7C, the mean distance information Sc is given by the mean value (100.1 meters) of all values of the plurality of pieces of distance information Bc in the detected behavior information B associated with the single behavior “left turn” shown in FIG. 7B. Thus, statistical relation information Sr is obtained, wherein the statistical relation information Sr includes the mean distance information Sc produced by the mean distance determination unit 49 and the feature identification information Bb that is common for all pieces of detected behavior information B associated with the same behavior. Thus, in the present example, the mean distance determination unit 49 functions as the statistical relation information generation unit adapted to produce statistical relation information Sr statistically determined from a plurality of pieces of relation information Br associated with the same behavior indicated in a plurality of pieces of detected behavior information B.

The learned behavior information generator 50 functions as a unit adapted to produce learned behavior information S indicating a result of learning on a behavior of the vehicle C related to a particular feature on the basis of the detected behavior information B stored in the learned behavior database DB4. In the present example, the learned behavior information generator 50 produces learned behavior information S on the basis of a plurality of pieces of detected behavior information B associated with the same behavior detected a plurality of times and stored in the learned behavior database DB4. The learned behavior information S includes the behavior property information Ba associated with the same behavior indicated in the plurality of pieces of detected behavior information B and the statistical relation information Sr statistically determined from the plurality of pieces of relation information Br associated with the same behavior.

The statistical relation information Sr includes the mean distance information Sc produced by the mean distance determination unit 49 and the feature identification information Bb that is common for the plurality of pieces of detected behavior information B associated with the same behavior. Thus, the learned behavior information S relates behavior property information Ba and feature identification information Bb which are common for a plurality of pieces of detected behavior information B associated with a particular single behavior to mean distance information Sc indicating the mean value of a plurality of pieces of distance information Bc associated with the same behavior indicated in a plurality of pieces of detected behavior information B associated with the same behavior. In the example shown in FIG. 7C, the learned behavior information S includes a single piece of behavior property information Ba having a value “left turn” indicating a behavior, a single piece of feature identification information Bb having identification information “ID=XXXX,” and mean distance information Sc having a value of 1001.1 related to the behavior property information Ba and the feature identification information Bb. The learned behavior information generator 50 stores the produced learned behavior information S in the behavior database DB5.

When only one piece of detected behavior information B is stored in the learned behavior database DB4 for a particular behavior, the learned behavior information generator 50 produces learned behavior information S on the basis of this one piece of detected behavior information B. In this case, the mean distance information Sc included in the statistical relation information Sr of the learned behavior information S is derived from the distance information Bc of the detected behavior information B, and thus the learned behavior information S has substantially the same content as the detected behavior information B. In the following explanation, it is assumed that learned behavior information S is produced on the basis of a plurality of pieces of detected behavior information B.

The behavior prediction unit 51 is adapted to predict a behavior of the vehicle C on the basis of the learned behavior information S stored in the behavior database DB5. Specifically, when a particular feature indicated by the learned behavior information S is detected via image recognition, the behavior prediction unit 51 predicts that the behavior of the vehicle C related to the detected particular feature will occur, and the behavior prediction unit 51 outputs a result of the prediction of the behavior. To accomplish the prediction, when the image recognition unit 24 detects a particular feature via image recognition, the behavior prediction unit 51 acquires learned behavior information S associated with the detected particular feature from the behavior database DB5 by reading the learned behavior information S from the behavior database DB5 on the basis of the feature identification information Bb included in each learned behavior information S. The behavior prediction unit 51 then predicts the behavior of the vehicle C on the basis of the behavior property information Ba included in the acquired learned behavior information S and the mean distance information Sc.

Specifically, the behavior prediction unit 51 predicts that the behavior of the vehicle C indicated by the behavior property information Ba will occur when the vehicle C travels the distance indicated by the mean distance information Sc from the feature recognition position at which the feature was detected via the image recognition. The behavior prediction unit 51 supplies the result of the prediction of the behavior to various control units of the vehicle C thereby to properly control the operation of the vehicle C. Examples of units/devices to which the prediction result is supplied are the navigation processing unit 27 adapted to perform calculation/processing to output guidance information and the vehicle controller 52 which is a controller adapted to reproduce an operation performed by a driver or optimize the operation of the vehicle when a driver drives the vehicle or when an external factor is applied to the vehicle. Some specific examples will be shown later in terms of manners in which the prediction of the behavior is used.

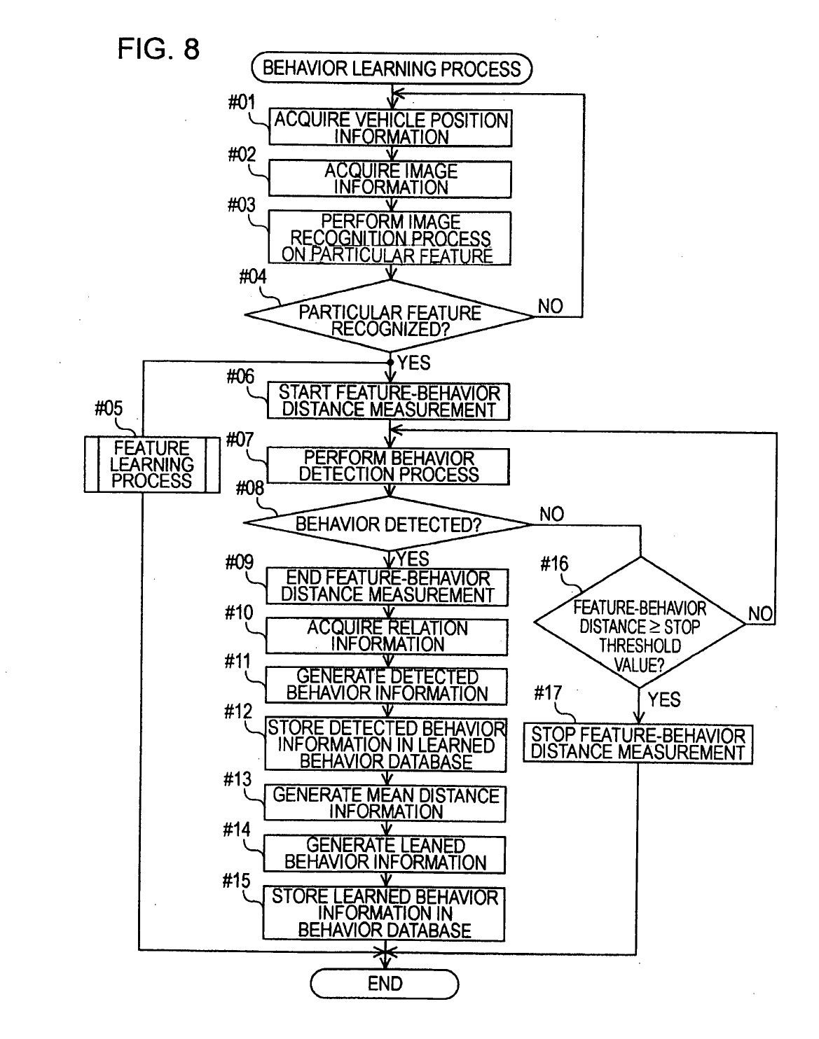

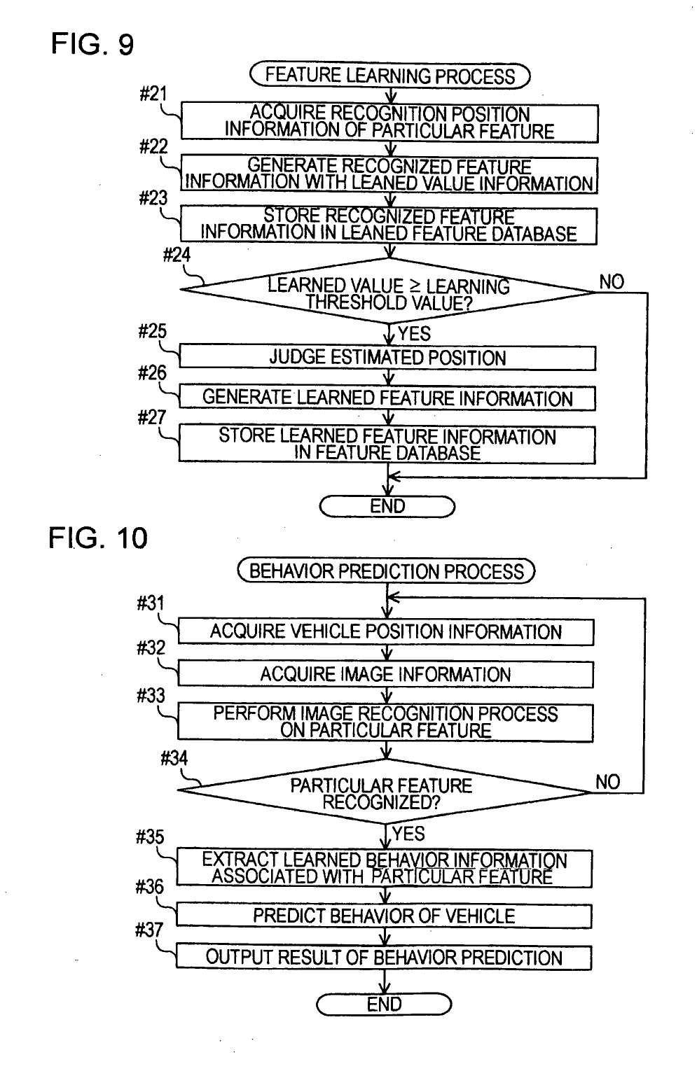

Next, an exemplary vehicle behavior learning method will be described with reference to FIGS. 8 and 9. The exemplary method may be implemented, for example, by one or more components of the above-described navigation apparatus 1, vehicle behavior learning apparatus 2, and/or vehicle position recognition apparatus 3. For example, the method may be implemented by a controller executing a computer-executable program that implements one or more of the above-described units. However, even though the exemplary structure of the above-described apparatuses may be referenced in the description, it should be appreciated that the structure is exemplary and the exemplary method need not be limited by any of the above-described exemplary structure.

First, as shown in FIG. 8, vehicle position information P is acquired by the vehicle position information acquisition unit 16 (step #01). Image information G associated with the vicinity of the vehicle C taken by the image pickup apparatus 11 is acquired by the image information acquisition unit 12 (step #02). Image recognition of a particular feature included in the image information G is performed by the image recognition unit 24 (step #03). If no feature is detected in step #03 (step #04=No), the method returns to step #01 to again acquire vehicle position information P and image information G. When in step #03, a particular feature included in the image information G is detected (step #04=Yes), a feature learning process is executed (step #05). An example of a method that may be used to implement this process is shown in FIG. 9.

In parallel with the feature learning process in step #05, the distance information generator 46 of the relation information generator 45 starts the measurement of the feature-behavior distance L (step #06). Note that the feature-behavior distance L refers to the distance from the position at which the feature was detected in step #03 to the position at which a behavior of the vehicle C is detected in step #07. In step #06, the position of the vehicle C when the particular feature was detected in step #03 is set as a measurement start point, the distance measurement is started. The behavior detector 17 then performs a process of detecting a behavior of the vehicle C (step #07).

In this behavior detection process in step #07, the behavior detector 17 is maintained in a state that allows the behavior detector 17 to detect a behavior of the vehicle C. While no behavior of the vehicle C is detected (step #08=No), if the measured feature-behavior distance L has reached a value equal to or greater than a predetermined threshold value (step #16=Yes), the measurement of the feature-behavior distance L is stopped (step #17), and the behavior learning method is ended. On the other hand, when the measured feature-behavior distance L is smaller than the predetermined threshold value (step #16=No), if a behavior of the vehicle C is detected (step #08=Yes), the measurement of the feature-behavior distance L by the distance information generator 46 is completed (step #09). Thereafter, relation information Br is acquired which includes distance information Bc indicating the measured feature-behavior distance L and feature identification information Bb produced by the feature identification information generator 47 (step #10).

Next, the detected behavior information generator 48 produces detected behavior information B including behavior property information Ba indicating the property of the behavior of the vehicle C detected in step #07 and the relation information Br acquired in step #10 for the detected behavior (step #11). The produced detected behavior information B is stored in the learned behavior database DB4 (step #12). Next, on the basis of a plurality of pieces of detected behavior information B associated with the same behavior stored in the learned behavior database DB4 via the above process, the mean distance determination unit 49 produces mean distance information Sc (step #13). As described above, the mean distance information Sc is information indicating the mean value of a plurality of pieces of distance information Bc associated with the same behavior indicated in a plurality of pieces of detected behavior information B associated with the same behavior.

Thereafter, on the basis of a plurality of pieces of detected behavior information B stored in the learned behavior database DB4 for the same behavior detected a plurality of times, the learned behavior information generator 50 produces learned behavior information S indicating a result of the learning on the behavior of the vehicle C related to the detected particular feature (step #14). The produced learned behavior information S is stored in the behavior database DB5 (step #15). Thus, the behavior learning method performed by the vehicle behavior learning apparatus 2 is completed.

The feature learning process, which is part of the behavior learning process, according to the present example is described below. An example of a method that may be used to implement the feature learning process in step #05 in FIG. 8 is shown in FIG. 9. First, as shown in FIG. 9, the recognition position information acquisition unit 41 acquires recognition position information associated with the feature detected in step #03 in FIG. 8 on the basis of vehicle position information P (step #21). Next, the recognized feature information generator 42 produces recognized feature information A including information indicating a learned value (step #22). That is, as described above, the recognized feature information A is produced such that the feature property information produced by the feature property information generator 25 for the detected particular feature when the feature was detected via image recognition is related to the information indicating the learned value in each position range based on the recognition position information acquired in step #21 for the detected particular feature.

The recognized feature information A including information about learned values such as that shown in FIG. 5B is stored in the learned feature database DB3 (step #23). When any learned value indicated by the recognized feature information A for the detected particular feature stored in the learned feature database DB3 is smaller than the predetermined threshold value T1 (step #24=No), the feature learning process is ended.

On the other hand, when a learned value indicated by the recognized feature information A stored in the learned feature database DB3 for the detected feature is equal to or greater than the predetermined threshold value T1 (step #24=Yes), the estimated position acquisition unit 43 determines the estimated position pg of the particular feature (step #25). Thereafter, the learned feature information generator 44 produces learned feature information Fb by which the estimated position pg determined in step #25 for the particular feature is related to the feature property information of the particular feature included in the recognized feature information A (step #26). The produced learned feature information Fb is then stored in the feature database DB2 (step #27). The feature learning process is then ended.

Next, an exemplary vehicle behavior prediction method will be described with reference to FIG. 10. The exemplary method may be implemented, for example, by one or more components of the above-described navigation apparatus 1, vehicle behavior learning apparatus 2, and/or vehicle position recognition apparatus 3. For example, the method may be implemented by a controller executing a computer-executable program that implements one or more of the above-described units. However, even though the exemplary structure of the above-described apparatuses may be referenced in the description, it should be appreciated that the structure is exemplary and the exemplary method need not be limited by any of the above-described exemplary structure.

As shown in FIG. 10, first, the vehicle position information acquisition unit 16 acquires vehicle position information P (step #31). Next, the image information acquisition unit 12 acquires image information G of an image of the vicinity of the vehicle C taken by the image pickup apparatus 11 (step #32). Thereafter, the image recognition unit 24 performs the image processing on the image information G to detect a feature included in the image information G (step #33). If no feature is detected in step #33 (step #34=No), the processing flow returns to step #31 to again acquire vehicle position information P and image information G. If a particular feature is detected from the image information G in step #33 (step #34=Yes), the behavior prediction unit 51 acquires learned behavior information S associated with the detected particular feature by reading the learned behavior information S from the behavior database DB5 (step #35).

Based on the learned behavior information S acquired in step #35, the behavior prediction unit 51 predicts a behavior of the vehicle C (step #36). In this step, as described above, on the basis of the behavior property information Ba and the mean distance information Sc included in the learned behavior information S, the behavior prediction unit 51 predicts that the behavior of the vehicle C represented in the behavior property information Ba will occur when the vehicle C travels the distance indicated by the mean distance information Sc from the recognition position at which the particular feature was detected via the image recognition. Thereafter, the behavior prediction unit 51 supplies the result of the prediction of the behavior to various control units of the vehicle C thereby to properly control the operation of the vehicle C (step #37). Thus, the behavior prediction process performed by the vehicle behavior learning apparatus 2 is completed.

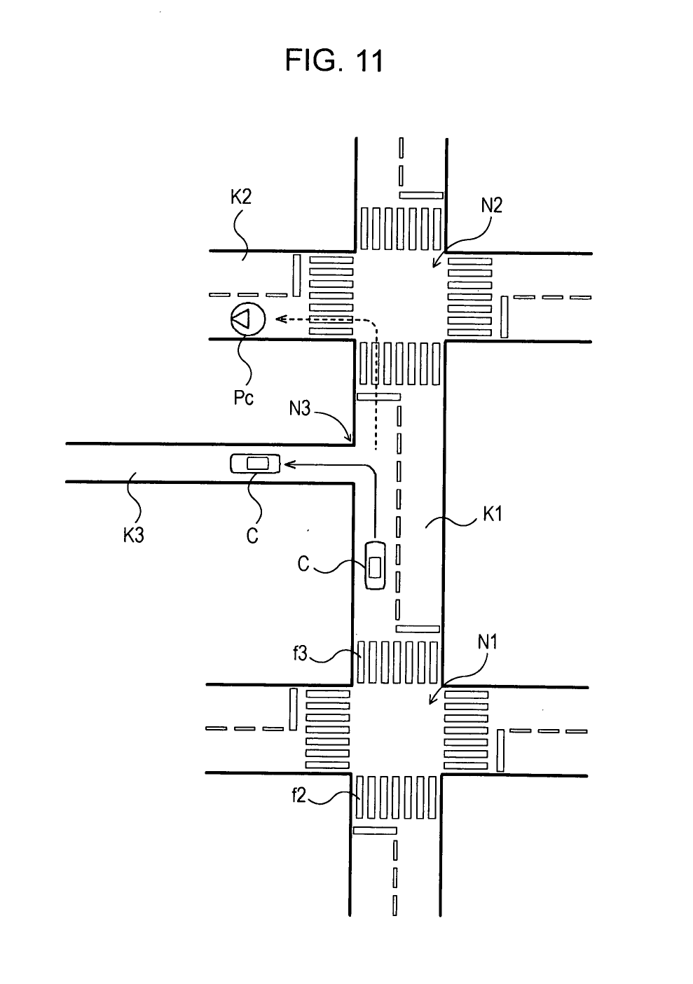

A specific example of learning performed by the vehicle behavior learning apparatus 2 is described below. FIG. 11 is a diagram schematically illustrating an example of a manner in which a vehicle behavior is learned on the basis of a trajectory of vehicle position information P acquired by the vehicle position information acquisition unit 16. In this specific example, the vehicle C runs along a main road K1. At a small intersection N3 before a large intersection N2 at which the main road K1 crosses another main road K2, the vehicle C turns left to a narrow street K3. When the narrow street K3 is located close to the main road K2, that is, the distance between intersections N2 and N3 is small, there is a possibility that the vehicle position information acquisition unit 16 map-matches the current position of the vehicle C indicated by the vehicle position information P to a wrong road.

For example, there is a possibility that the current position of the vehicle C indicated by the vehicle position information P is incorrectly map-matched to the main road K2 as represented by a broken line in FIG. 11, and the vehicle position mark Pc indicating the current position of the vehicle C represented by the vehicle position information P is incorrectly displayed on the main road K2 on the display/input unit 29, although the vehicle C actually turns left to the narrow street K3 as represented by a solid line in FIG. 11. Such wrong matching may be automatically corrected by the navigation processing unit 27 or manually by a driver. However, even when a correction is made, the vehicle position mark Pc is displayed at a wrong point different on the display/input unit 29 for a certain time period, which may be short or long. The vehicle behavior learning apparatus 2 is adapted to minimize the possibility of such wrong matching.

In the example shown in FIG. 11, before reaching the intersection N3, a driver of the vehicle C operates a direction indicator and reduces the speed of the vehicle C by operating the brakes. At the intersection N3, the driver operates a steering wheel so as to make a left turn. The operations of the direction indicator, the brakes, and the steering wheel performed by the driver are detected as behaviors of the vehicle by the behavior detector 17. When the vehicle C turns to the left, a change in the running direction of the vehicle C is detected by the direction sensor 24. This change in the running direction is detected by the behavior detector 17 as a behavior of the vehicle C due to an operation performed by the driver. In the present example, before the left turn is detected as a behavior of the vehicle C, the vehicle C passed through an intersection N1. Before and after the intersection N1, there are pedestrian crossings that are detected as particular features f2 and f3 by the image recognition unit 24. Thus, in this example, detected behavior information B indicating a behavior of the vehicle C related to one or both of the particular features f2 and f3 is produced and stored in the learned behavior database DB4.

When the left turn to the narrow street K3 is performed on the way home, the vehicle C passes through the same path from the main road K1 to the narrow street K3 a plurality of times. Therefore, a plurality of pieces of detected behavior information B associated with the same behavior of the vehicle C are stored in the learned behavior database DB4. On the basis of the plurality of pieces of detected behavior information B, learned behavior information S indicating a result of learning on the behavior of the vehicle C in association with the particular feature f2 and f3 is produced and stored in the behavior database DB5. The produced learned behavior information S includes behavior property information Ba indicating behaviors of the vehicle C such as a left turn operation and an operation of the direction indicator performed by the driver, feature identification information Bb identifying one or both of the particular features f2 and f3, and mean distance information Sc indicating the mean feature-behavior distance L.

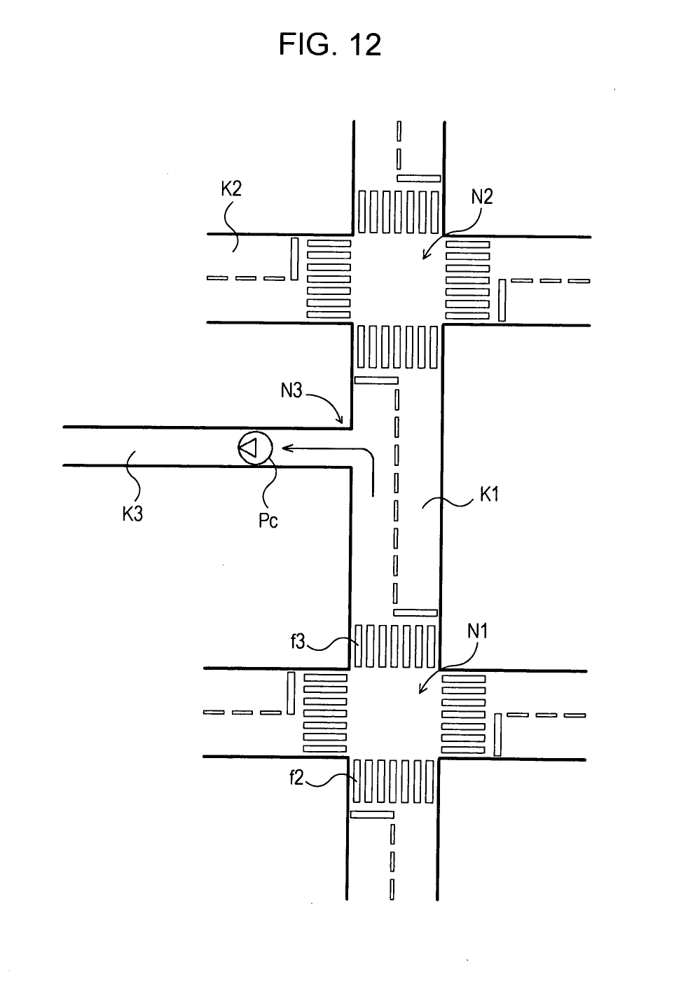

FIG. 12 is a diagram schematically illustrating an example of a manner in which a result of vehicle behavior prediction is used by the navigation processing unit 27 in displaying the vehicle position mark. In the following explanation, it is assumed that learned behavior information S acquired in the above-described manner for the vehicle C has been stored in the behavior database DB5, and the vehicle C is now on the main road K1. When the vehicle C passes through the intersection N1, pedestrian crossings are detected as particular features f2 and f3 by the image recognition unit 24. The behavior prediction unit 51 acquires learned behavior information S related to the particular feature f2 and f3 by reading the learned behavior information S from the behavior database DB5. On the basis of the acquired learned behavior information S, the behavior prediction unit 51 predicts that the vehicle C will probably make a left turn at the intersection N3. The behavior prediction unit 51 supplies the result of the prediction of the behavior to the navigation processing unit 27. If the vehicle C actually makes a left turn at the predicted position, the navigation processing unit 27 determines that the vehicle C has entered not the main road K2 but the narrow street K3 and displays the vehicle position mark Pc on the narrow street K3 on the display/input unit 29. In this case, the behavior prediction unit 51 may preferably supply the result of the prediction of the behavior to the vehicle position information acquisition unit 16 thereby to correct the vehicle position information P.

As described above, use of the vehicle behavior learning apparatus 2 makes it possible to increase the accuracy in displaying the vehicle position mark on the navigation apparatus 1 and/or providing route guidance.

In the example of FIGS. 11 and 12, described above, driver's operations accepted at various parts of the vehicle C and operations of the vehicle C which occur in response to operations performed by the driver are detected as behaviors of the vehicle C by the behavior detector 17. In another example (Example 2) described below, an operation of the vehicle C that occurs in response to an external factor applied from the outside to the vehicle C is detected as a behavior of the vehicle C.

There is a system in which the damping force of a suspension of the vehicle C is controlled in accordance with road information supplied from the navigation apparatus 1 so as to improve steering stability at curves or so as to properly control damping force of vibrations at a step. The above control is realized in cooperation between the control of the suspension and the navigation apparatus 1, and thus this systems is called a navigation-assisted suspension system. In general, the navigation-assisted suspension system operates in accordance with vehicle position information P acquired by the navigation apparatus 1 from the GPS receiver 13, the direction sensor 14, and the distance sensor 15. However, the vehicle position information P may have an error as described above, and the error can cause the suspension to be controlled at a wrong position.

Use of the vehicle behavior learning apparatus 2 makes it possible to detect the behavior of the vehicle C at a curve or a step by the vibration sensor 19, the direction sensor 14, the acceleration sensor 21, or the like, and store the detected behavior as detected behavior information B in the learned behavior database DB4. If the vehicle C passes through the same point a plurality of times, a plurality of pieces of detected behavior information B are stored in the learned behavior database DB4, and learned behavior information S associated with the behavior is produced on the basis of the plurality of pieces of detected behavior information B stored in the learned behavior database DB4 and the produced learned behavior information S is stored in the behavior database DB5.

On the basis of the learned behavior information S produced and stored in the above-described manner, the behavior prediction unit 51 predicts the behavior of the vehicle C that will occur at a step or a curve related to a corresponding feature. Information indicating the result of the behavior prediction is supplied to a controller (vehicle controller 52) of the navigation-assisted suspension system, and the controller controls the suspension in accordance with the supplied information. Thus, when a road has a step at a particular point, it is predicted that a vibration or a shock will occur at this particular point, and the suspension is properly controlled in accordance with the prediction. Thus, it becomes possible to control the suspension more properly.

In this Example 2, the detected behavior of the vehicle C is due to an external factor applied from the outside to the vehicle C. Therefore, the behavior does not necessarily depend on a driver of the vehicle C, but substantially depends on roads. Therefore, for example, the learned behavior database DB4 and the behavior database DB5 may be preferably disposed in a server or the like capable of communicating with a plurality of vehicles so that the detected behavior information B and the learned behavior information S can be shared by a plurality of vehicles. This implementation makes it possible to more quickly learn the behavior of the vehicle that occurs at a particular point on a road.

In another example (Example 3) described below, on the basis of the road information Ra stored in the map database DB1 and in response to an operation performed by a driver, the engine and/or the automatic transmission mechanism of the vehicle C are properly controlled. In this case, the control of the shift of the automatic transmission mechanism is performed in cooperation with the navigation apparatus 1, and thus this control system is called a navigation-assisted shift control. When the vehicle C goes uphill, the vehicle C runs at a low speed or runs at a high speed while performing kick-down, depending on a preference of a driver. The behavior detector 17 detects the kick-down operation as detected behavior information B. If the same behavior is detected with respect to the same feature a plurality of times, the driving operation is learned as a tendency in the operation performed by the driver. That is, this behavior is described in learned behavior information S in association with the feature and is stored in the behavior database DB5.

On the basis of the stored learned behavior information S, the behavior prediction unit 51 predicts that the shift down will be necessary when the related feature is detected by the image recognition unit 24 via image recognition. On the basis of the prediction, the navigation-assisted shift control system properly controls the shift operation taking into account other factors such as fuel consumption. The control may be applied to an engine and various kinds of mechanisms of the power train such as a transmission mechanism. In the case of a hybrid car having both an engine and an electric motor as driving power sources, each driving power source can be controlled so as to be maintained in an optimum operating state.

In another example (Example 4), an operation of a sun visor performed by a driver may be detected as a behavior of the vehicle C due to acceptance of an operation performed by a driver. In this case, time information and/or date information may be acquired from the GPS receiver 13. That is, the operation of the sun visor, the time zone, the point, and the direction where the driver feels dazzled may be described in learned behavior information S stored. If the behavior prediction unit 51 predicts, on the basis of the learned behavior information S, that the driver will feel dazzled, various apparatus are controlled to properly handle the situation. For example, the brightness of the display screen of the display/input unit 29 and/or the electric sun visor is driven.

In another example (Example 5), an operation of an air conditioner performed by a driver may be detected on the basis of a signal supplied from the air-conditioner switch 22, and may be regarded as a behavior of the vehicle C due to acceptance of operation performed by the driver. Specifically, for example, if a driver, who usually uses an air conditioner in a mode in which external air is inhaled, switches into a mode in which air is circulated internally, at a particular point, learned behavior information S associated with this behavior is produced and stored. Such a behavior can occur, for example, when the vehicle is running on a main road having a lot of traffic, if a driver operates the air-conditioner switch 22 to prevent exhaust gas from other vehicles from entering the vehicle C. If the behavior prediction unit 51 predicts on the basis of the learned behavior information S that the air conditioner will be operated, then, in accordance with the prediction, the controller of the air conditioner automatically switches the operation from the mode in which external air is inhaled to the mode in which air is circulated internally. If a delay occurs in switching the operation mode, exhaust gas will intrude into the vehicle C. Such intrusion of air will make the driver uncomfortable, even if the amount of intrusion is small. The automatic control of the air conditioner according to the prediction ensures comfort in the vehicle.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

For example, in the examples described above, the relation information Br is produced by the relation information generator 45 so as to include the distance information Bc produced by the distance information generator 46 and the feature identification information Bb produced by the feature identification information generator 47. However, for example, the relation information Br may include only one of the distance information Bc or the feature identification information Bb, or the relation information Br may include additional information such as information indicating a relationship between a behavior of the vehicle and a particular feature detected by the image recognition unit before the detection of the behavior.

In the example described with reference to FIG. 7B, a plurality of pieces of detected behavior information B associated with the same behavior may be combined in a single set of information including common behavior property information Ba and feature identification information Bb and stored in the learned behavior database DB4. However, a plurality of pieces of detected behavior information B associated with the same behavior may be separately stored in the learned behavior database DB4.

In the examples described above, statistical relation information Sr is statistically determined from a plurality of pieces of relation information Br associated with the same behavior indicated in a plurality of pieces of detected behavior information B such that mean distance information Sc indicating the mean value of a plurality of pieces of distance information Bc associated with the same behavior is determined by the mean distance determination unit 49. However, on the basis of a distribution of a plurality of pieces of distance information Bc associated with the same behavior, the mode or the median of the distribution, or other representatives may be employed as the statistical distance information, statistical relation information Sr may be produces so as to include this statistical distance information and feature identification information Bb.

In the examples described above, the vehicle behavior learning apparatus 2 is configured so as to include the behavior prediction unit 51, and the prediction result in terms of the behavior of the vehicle C is supplied to the vehicle controller 52 or the like. However, the vehicle behavior learning apparatus 2 may not include the behavior prediction unit 51. Specifically, for example, the vehicle behavior learning apparatus 2 may be configured so as to include a vehicle position information correction unit to correct the vehicle position information P acquired by the vehicle position information acquisition unit 16 on the basis of a behavior of the vehicle C in terms of changing a running direction such as a right turn or a left turn and on the basis of a road shape described in the map information M so that the change in the running direction is correctly expressed on the map. In this case, the vehicle behavior learning apparatus 2 functions as a part of the vehicle position recognition apparatus.

In the examples described above, the recognition position information acquired by the recognition position information acquisition unit 41 indicates a position of the vehicle C when a feature is successfully detected via image recognition. However, when a particular feature is successfully detected via image recognition, the position of the detected particular feature on a road relative to the vehicle position information P may be calculated on the basis of the vehicle position information P and the result of image recognition of the image information G, and the position of the particular feature on the road may be acquired as recognition position information by the recognition position information acquisition unit 41.

In the examples described above, the estimated position acquisition unit 43 determines the estimated recognized position pa of a particular feature by determining the mode of a distribution of a plurality of pieces of recognized feature information A associated with the same particular feature, and the estimated position acquisition unit 43 then converts the estimated recognized position pa into a position on a road thereby obtaining an estimated position pg of the particular feature. However, another representative value of the distribution of the recognized feature information A, such as the mean value or the median, may be preferably employed as the estimated recognized position pa of the particular feature.

In the examples described above, various road markings on road surface may be detected as particular features. However, other various features disposed on sides of roads or disposed at other locations may be detected as particular features. Some specific examples of such features are road signs, guide signs, advertising displays, traffic signals, and manholes.

In the examples described above, databases DB1 to DB5 are disclosed only by way of example, and configurations of the databases DB1 to DB5 shown in the examples do not define hardware configurations. For example, the feature database DB2 and the learned feature database DB3 may be combined into a single database, and the learned behavior database DB4 and the behavior database DB5 may be combined into a single database. Alternatively, for example, the map database DB1 and the feature database DB2 may be combined into a single database. There can be many other alternative combinations as well.

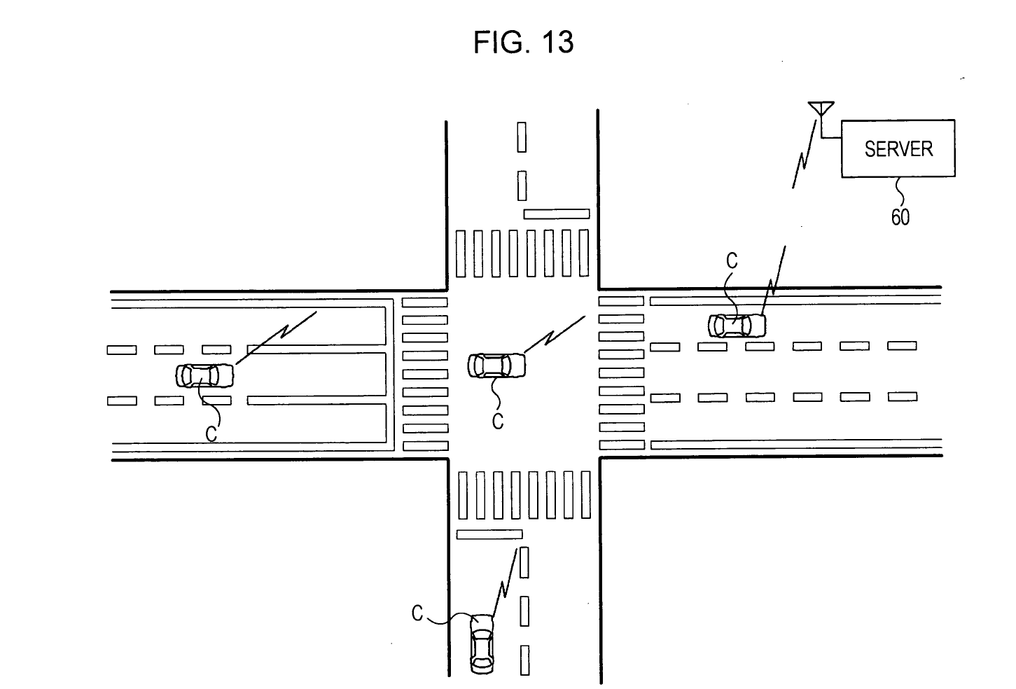

In the examples described above, all parts of the navigation apparatus 1, including the vehicle behavior learning apparatus 2, are installed in the vehicle C. However, for example, some parts of the vehicle behavior learning apparatus 2, including one or both of the learned feature database DB3 serving as the recognized feature storage unit and the learned behavior database DB4 serving as the detected behavior storage unit, may be installed in a server 60 adapted to be capable of communicating with a plurality of vehicles C via a radio communication channel or the like, as shown in FIG. 13.

By configuring the vehicle behavior learning apparatus 2 in such a manner, it becomes possible to accumulate learning results in terms of behaviors of a plurality of vehicles C and learning results in terms of particular feature in the learned behavior database DB4 or the learned feature database DB3 installed in the server 60. Thus, it becomes possible to quickly produce learned behavior information S or learned feature information Fb using a greater number of pieces of detected behavior information B or recognized feature information A.

The parts of the vehicle behavior learning apparatus 2 installed in the server 60 are not limited to the learned feature database DB3 and the learned behavior database DB4, but any part other than parts necessary to be installed in the vehicle C such as the image pickup apparatus 11 and the vehicle position information acquisition unit 16 may be installed in the server 60. For example, any one or more of the map database DB1, the feature database DB2, and the behavior database DB5 may be installed in the server 60.

In the examples described above, the vehicle behavior learning apparatus 2 is used in the navigation apparatus 1. However, the vehicle behavior learning apparatus 2 may be used in an apparatus other than the navigation apparatus 1, such as a running controller of a vehicle.

What is claimed is:

1. A vehicle behavior learning apparatus, comprising:
a controller that:
acquires image information of an area around a vehicle;
performs image recognition of a particular feature included in the image information;
detects a behavior of the vehicle;
acquires relation information indicating the relationship between the detected behavior and the recognized particular feature;
stores detected behavior information including behavior property information indicating a property of the detected behavior of the vehicle and the acquired relation information associated with the behavior in a memory; and
produces learned behavior information indicating a result of learning of the behavior related to the particular feature on the basis of the stored detected behavior information.

2. The vehicle behavior learning apparatus according to claim 1, wherein the detected behavior of the includes at least one of:
an operation of the vehicle; and
acceptance by a part of the vehicle of an operation performed by a driver.

3. The vehicle behavior learning apparatus according to claim 1, wherein the relation information includes distance information indicating the distance from a recognized location of the particular feature to a position of the vehicle at which the behavior of the vehicle is detected.

4. The vehicle behavior learning apparatus according to claim 1, wherein the relation information includes feature identification information identifying the particular recognized feature.

5. The vehicle behavior learning apparatus according to claim 1, wherein the controller acquires the relation information on the basis of at least one of:
information indicating a detected travel distance of the vehicle; and
information indicating an acquired current position of the vehicle.

6. The vehicle behavior learning apparatus according to claim 1, wherein the learned behavior information includes the behavior property information associated with a particular behavior and statistical relation information, the behavior property information being produced on the basis of a plurality of pieces of detected behavior information associated with the same particular behavior detected a plurality of times and stored in the memory, the statistical relation information being determined statistically from the plurality of pieces of relation information associated with the particular behavior.

7. The vehicle behavior learning apparatus according to claim 1, wherein the particular feature is a road marking formed on the surface of a road.

8. The vehicle behavior learning apparatus according to claim 1, wherein the memory stores the produced learned behavior information.

9. The vehicle behavior learning apparatus according to claim 1, wherein the controller:
detects a particular feature indicated by the learned behavior information via image recognition;
predicts that a behavior of the vehicle related to the detected particular feature will occur; and
outputs a result of the prediction of the behavior.

10. The vehicle behavior learning apparatus according to claim 9, wherein the controller uses the result of the prediction of the behavior to perform at least one of:
a calculation for outputting guidance information associated with the vehicle; and
a process for outputting guidance information associated with the vehicle.

11. The vehicle behavior learning apparatus according to claim 9, wherein the controller uses the result of the prediction of the behavior to a control apparatus disposed in a vehicle, the control apparatus being adapted to reproduce the operation performed by the driver.

12. The vehicle behavior learning apparatus according to claim 9, wherein the controller supplies the result of the prediction of the behavior to a control apparatus adapted to optimize the operation of the vehicle.

13. The vehicle behavior learning apparatus according to claim 1, wherein the controller:
acquires recognition position information indicating a recognition position of a particular recognized feature;
stores recognized feature information including feature property information representing a property of the particular recognized feature and the acquired recognition position information in the memory; and
produces learned feature information representing a result of learning of the particular feature on the basis of a plurality of pieces of recognized feature information produced for the same particular feature detected a plurality of times via image recognition and stored in the memory.

14. The vehicle behavior learning apparatus according to claim 13, wherein the learned feature information includes the feature property information associated with the same particular feature indicated by the plurality of pieces of recognized feature information and estimated position information statistically determined from the plurality of pieces of recognition position information associated with the particular feature.

15. The vehicle behavior learning apparatus according to claim 13, wherein the memory stores the learned feature information produced by the learned feature information generation unit.

16. The vehicle behavior learning apparatus according to claim 13, wherein the memory is included in a server that communicates with a plurality of other vehicles such that the memory is capable of communicating with the plurality of other vehicles; and
the memory is adapted to store recognized feature information supplied from one or more of the plurality of other vehicles.

17. The vehicle behavior learning apparatus according to claim 1, wherein:
the memory is included in a server that communicates with a plurality of other vehicles such that the memory is capable of communicating with the plurality of other vehicles; and
memory is adapted to store detected behavior information supplied from one or more of the plurality of other vehicles.

18. A navigation apparatus, comprising:
a vehicle behavior learning apparatus according to claim 1; and
a map information storage unit in which map information is stored;
wherein the controller operates to provide guidance with reference to one or both of the learned behavior information and the map information.

19. A vehicle behavior learning method, comprising:
acquiring image information of an area around a vehicle;
performing image recognition of a particular feature included in the image information;
detecting a behavior of the vehicle;
acquiring relation information indicating the relationship between the detected behavior and the recognized particular feature;
storing detected behavior information including behavior property information indicating a property of the detected behavior of the vehicle and the acquired relation information associated with the behavior in a memory; and
producing learned behavior information indicating a result of learning of the behavior related to the particular feature on the basis of the stored detected behavior information.

20. A computer-readable storage medium storing a computer-executable program usable to learn vehicle behavior, the program comprising:
instructions for acquiring image information of an area around a vehicle;
instructions for performing image recognition of a particular feature included in the image information;
instructions for detecting a behavior of the vehicle;
instructions for acquiring relation information indicating the relationship between the detected behavior and the recognized particular feature;
instructions for storing detected behavior information including behavior property information indicating a property of the detected behavior of the vehicle and the acquired relation information associated with the behavior in a memory; and
instructions for producing learned behavior information indicating a result of learning of the behavior related to the particular feature on the basis of the stored detected behavior information.
